(19) United States
(12) Patent Application Publication
(10) Pub. No.: US 2014/0205851 A1
(43) Pub. Date: Jul. 24, 2014

(54) MAGNETIC CONTACTS FOR ELECTRONICS APPLICATIONS

(71) Applicants: Ravindranath V. MAHAJAN, Chandler, AZ (US); Aleksandar ALEKSOV, Chandler, AZ (US); Debendra MALLIK, Chandler, AZ (US); Ian A. YOUNG, Portland, OR (US); Rajasekaran SWAMINATHAN, Tempe, AZ (US); Sairam AGRAHARAM, Chandler, AZ (US); John S. GUZEK, Chandler, AZ (US)

(72) Inventors: Ravindranath V. MAHAJAN, Chandler, AZ (US); Aleksandar ALEKSOV, Chandler, AZ (US); Debendra MALLIK, Chandler, AZ (US); Ian A. YOUNG, Portland, OR (US); Rajasekaran SWAMINATHAN, Tempe, AZ (US); Sairam AGRAHARAM, Chandler, AZ (US); John S. GUZEK, Chandler, AZ (US)

(21) Appl. No.: 13/748,489

(22) Filed: Jan. 23, 2013

(51) Int. Cl. B32B 7/12; B32B 15/04; H01F 1/42

(52) U.S. Cl. CPC B32B 7/12; H01F 1/42; B32B 15/043
USPC 428/554; 156/272.4; 252/62.51 R; 252/62.55; 428/548

(57) ABSTRACT

An interconnect structure for electrically joining two surfaces includes magnetic attachment structures and an anisotropic conductive adhesive (ACA). Magnetic attachment structures on a first surface are magnetically attracted to magnetic attachment structures on a second surface. Opposing magnetic attachment structures are joined via an ACA, which conducts electricity when compressed, and is electrically insulating when not compressed. The magnetic attraction between opposing magnetic attachment structures generates a sufficient force to maintain compression of the intervening ACA in order to sustain a desired level of electrical conductivity between the first surface and second surface. A method for joining two surfaces using the interconnect structure is disclosed. Additionally, a magnetic anisotropic conductive adhesive having magnetic conductive particles dispersed therein is disclosed.

### BACKGROUND

Conventional solder-based mounting methods require complicated, high temperature processes that incorporate expensive materials and do not scale easily to accommodate smaller, finer-pitch interconnections. Anisotropic conductive adhesives (ACAs) provide an alternative to solder-based methods that is lighter weight, has a thinner profile, requires simpler, lower temperature processing, is suitable for use with finer pitch contacts, is lead free, and is more cost effective as compared to solder and underfill-based methods. Interconnection structures incorporating ACAs can maintain strong adhesion, good electrical performance, high mechanical reliability, and effective thermal conductivity.

Anisotropic conductive adhesives include conductive particles dispersed within an insulating matrix material. The matrix of an ACA can have a variety of adhesive formats, such as a paste (ACP), a tape (ACT), or a film (ACF). In an unstressed state, the insulating matrix prevents electrical contact between adjacent conductive particles, and the ACA is non-conductive. When a portion of an ACA is compressed between two opposing electrically conductive surfaces, such as contact bumps, the matrix material yields to allow the conductive particles to come into contact with adjacent conductive particles and with the conductive surfaces, thereby establishing an electrically conductive path only between the two contact surfaces while the uncompressed portions of the ACA remain non-conductive. As such, the conductive properties of the ACA are anisotropic; that is, they vary in different directions. Additionally ACA can be electrically conductive where compressed and electrically insulating where uncompressed. This allows an ACA to be applied over multiple bumps. Opposing bumps are mechanically and electrically joined, while adjacent bumps are electrically isolated. Generally, the use of an ACA requires sustained exterior pressure on the joined surfaces, for example via a clamp, in order to maintain a desired level of conductivity between opposing bumps.

### BRIEF DESCRIPTION OF THE DRAWINGS

FIG. 1A illustrates a cross-sectional view of an interconnect structure incorporating an anisotropic conductive tape (ACT) and magnetic attachment structures, according to an embodiment of the invention.

FIG. 1B illustrates a cross-sectional view of an interconnect structure incorporating an anisotropic conductive paste (ACP) and magnetic attachment structures, according to an embodiment of the invention.

FIG. 2A illustrates a cross-sectional view of an interconnect structure incorporating an anisotropic conductive tape (ACT) and magnetic attachment structures, according to an embodiment of the invention.

FIG. 2B illustrates a cross-sectional view of an interconnect structure incorporating an anisotropic conductive paste (ACP) and magnetic attachment structures, according to an embodiment of the invention.

FIGS. 3A-3C illustrate a cross-sectional view of electronic devices having interconnect structures incorporating an anisotropic conductive adhesive (ACA) and magnetic attachment structures, according to an embodiment of the invention.

FIGS. 4A-4E illustrate a cross-sectional view of an interconnect structure incorporating an ACA and magnetic attachment structures, according to an embodiment of the invention.

FIGS. 5A-5D illustrate a cross-sectional view of an interconnect structure incorporating an ACA and magnetic attachment structures, according to an embodiment of the invention.

FIG. 6A illustrates a cross-sectional view of an interconnect structure incorporating a magnetic anisotropic conductive tape and magnetic attachment structures, according to an embodiment of the invention.

FIG. 6B illustrates a cross-sectional view of an interconnect structure incorporating a magnetic anisotropic conductive paste and magnetic attachment structures, according to an embodiment of the invention.

FIG. 7 illustrates a computing system implemented with an interconnect structure incorporating an anisotropic conductive adhesive and magnetic attachment structures in accordance with an example embodiment of the invention.

### DETAILED DESCRIPTION

An interconnect structure incorporating anisotropic conductive adhesive (ACA) and magnetic attachment structures, a method of joining two substrates using the interconnect structure, and a magnetic anisotropic conductive adhesive are described. In various embodiments, description is made with reference to figures. However, certain embodiments may be practiced without one or more of these specific details, or in combination with other known methods and configurations. In the following description, numerous specific details are set forth, such as specific configurations, dimensions and processes, etc., in order to provide a thorough understanding of the present invention. In other instances, well-known semiconductor processes and manufacturing techniques have not been described in particular detail in order to not unnecessarily obscure the present invention. Reference throughout this specification to “one embodiment,” “an embodiment” or the like means that a particular feature, structure, configuration, or characteristic described in connection with the embodiment is included in at least one embodiment of the invention. Thus, the appearances of the phrase “in one embodiment,” “an embodiment” or the like in various places throughout this specification are not necessarily referring to the same embodiment of the invention. Furthermore, the particular features, structures, configurations, or characteristics may be combined in any suitable manner in one or more embodiment.

The terms “over”, “to”, “between” and “on” as used herein may refer to a relative position of one layer with respect to other layers. One layer “over” or “on” another layer or bonded “to” another layer may be directly in contact with the other layer or may have one or more intervening layers. One layer “between” layers may be directly in contact with the layers or may have one or more intervening layers.

In one aspect, embodiments of the invention describe an interconnect structure incorporating an ACA and magnetic attachment structures, which has improved interface and bulk conductivity as compared to interconnect structures incorporating an ACA and non-magnetic attachment structures. For example, an ACA adheres magnetic attachment structures on a first surface to magnetic attachment structures on a second surface. The ACA may be in the form of a tape, film, or paste. Each magnetic attachment structure formed on the first surface is magnetically attracted to a corresponding magnetic attachment structure on the second surface, according to an embodiment. The magnetic attraction between the magnetic attachment structures generates sufficient pressure on the intervening ACA to cause the conductive particles embedded within the matrix come into contact, establishing an electrical path between the contact surfaces of the opposing magnetic attachment structures. In an embodiment, the magnetic pressure eliminates the need for an external clamping force to sustain suitable conductivity through the ACA.

In an embodiment, the body of the magnetic attachment structure is a conductive material, and a magnetic layer on the conductive material forms the contact surface. In another embodiment, the entire magnetic attachment structure is formed from a magnetic conductive material. The magnetic materials may be solid magnetic metals, solid magnetic alloys or magnetic particles dispersed within a non-magnetic conductive matrix, such as a solder material. The magnetic material may be ferromagnetic, antiferromagnetic, or paramagnetic.

In another aspect, the structure incorporating an ACA and magnetic attachment structures allows for a simpler, lower temperature, lower cost mounting process as compared to solder-based mounting techniques and techniques incorporating ACAs and conventional (i.e. non-magnetic) attachment structures. For example, an anisotropic tape, film, or paste may be applied over a number of magnetic attachment structures on a first surface. The first surface may then be joined to a second surface having corresponding magnetic attachment structures having a magnetic polarity opposite to that of the magnetic attachment structures on the first surface. The magnetic attraction between opposing magnetic attachment structures may assist in the alignment of contacts during the mounting process. Once the magnetic attachment structures on the second surface have been brought into contact with the ACA, the magnetic attraction between opposing contacts compresses the ACA, establishing an electrically conductive path between the attachment structures. In an embodiment, the ACA is cured, which may assist in holding the magnetic attachment structures and conductive particles in a position to maintain conductivity. In addition, the process is applicable at the wafer level, which may further simplify processing.

In another aspect, embodiments of the invention describe a magnetic anisotropic conductive adhesive (ACA) having enhanced anisotropic conductivity. For example, the ACA includes conductive particles dispersed within the matrix material that are magnetic, so that when the ACA is compressed between two magnetic attachment structures, the conductive particles are attracted to the magnetic contact surfaces. An increased density of particles in proximity to the magnetic contact surfaces may increase the conductivity between the attachment structures. In addition, the reduced concentration of magnetic conductive particles between adjacent magnetic attachment structures may reduce the risk for shorting between adjacent contacts. In an embodiment, the matrix material is selected to enable limited movement of the magnetic conductive particles. For example, the magnetic conductive particles may be dispersed within a paste matrix, which prior to curing enables limited movement in response to the magnetic contact surfaces. The ACP may then be cured, locking the conductive particles and the magnetic attachment structures into place.

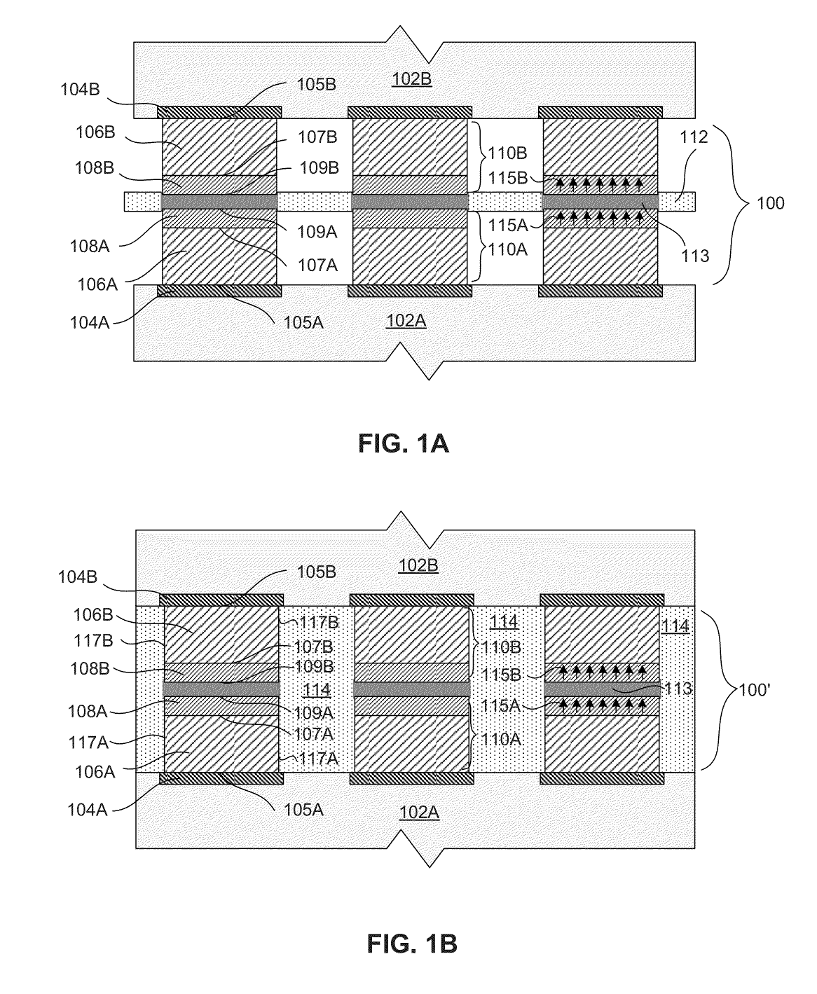

FIGS. 1A-1B illustrate a cross-sectional view of an interconnect structure incorporating an ACA and magnetic attachment structures having magnetically attracted contact surfaces, according to an embodiment of the invention. In FIG. 1A, interconnect structure 100 joins a first surface 102A and second surface 102B. In an embodiment, first surface 102A is the surface of a carrier substrate. A carrier substrate may be a substrate to which microelectronic and semiconductor devices are mounted and through which components are electrically interconnected, such as a printed circuit board (PCB), a motherboard, a daughter card, a package substrate, an interposer, or the like. For example, first surface 102A may be primarily composed of any appropriate structure material, including, but not limited to, bismaleimine triazine resin, fire retardant grade 4 material, polyimide materials, glass reinforced epoxy matrix material, and the like, as well as laminates or multiple layers thereof. In an embodiment, first surface 102A has bond pads 104A formed therein. Conductive pads 104A may be composed of any conductive metal, including but not limited to, copper, aluminum, and alloys thereof. The conductive pads 104A may be in electrical communication with conductive traces (not shown) within the first surface 102A. First surface 102A may additionally comprise a solder resist layer (not shown) through which conductive pads 104A are exposed.

In an embodiment, second surface 102B is the active surface of a microelectronic device, which may be a packaged microelectronic die, including, but not limit to a packaged microprocessor, a chipset, a graphics device, a wireless device, a memory device, an application specific integrated circuit, or the like. Second surface 102B may include an interconnect layer formed on an amorphous silicon or a silicon-germanium wafer. The interconnect layer may be a plurality of dielectric layers (not shown) having conductive traces (not shown) formed thereon and therethrough. In an embodiment, the interconnect layer forms conductive routes from integrated circuits (not shown) formed in and on the second surface 102B to at least one conductive pad 104B.

Each of first surface 102A and second surface 102B has at least one magnetic attachment structure 110A and 110B, respectively, formed thereon. In an embodiment, each magnetic attachment structure 110A/110B comprises conductive material 106A/106B and a magnetic layer 108A/108B. Conductive material 106A/106B is formed from any suitable electrically conductive material, for example, copper. In an embodiment, conductive material 106A/106B is formed from a solder material. In an embodiment, conductive material 106A/106B is formed on a conductive pad 104A/104B. Conductive material 106A/106B has a contact end 107A/107B and a pad end 105A/105B. The dimensions of conductive material 106A/106B will vary based on the particular application.

Magnetic contact layer 108A/108B covers contact end 107A/107B of conductive material 106A/106B, according to an embodiment of the invention. The thickness of magnetic layer 108A/108B may vary depending on the interconnect application and on the dimensions of conductive material 106A/106B. In an embodiment, magnetic layer 106A/106B is from 50 nm to 25 μm thick. Magnetic contact layer 108A/108B has a contact surface 109A/109B.

In an embodiment, magnetic contact layer 108A/108B includes a ferromagnetic material and has a permanent magnetic polarity 115A/115B. The magnetic polarity 115A normal to the contact surface 109A of magnetic contact layer 108A is the opposite of the magnetic polarity 115B normal to the contact surface 109B of magnetic contact layer 108B, so that magnetic contact layers 108A and 108B are magnetically attracted to one another, according to an embodiment of the invention. Magnetic contact layer 108A/108B may be a layer of ferromagnetic material such as, but not limited to, iron, colbalt, or nickel. In another embodiment, magnetic contact layer 108A/108B is formed from samarium or a samarium alloy, such as, but not limited to, Sm₁Co₅, Sm₂Co₁₇, and Sm₃Co₂₉. In another embodiment, magnetic contact layer 108A/108B is Nd₂Fe₁₄B. In another embodiment, magnetic contact layer 108A/108B is an iron alloy, such as, but not limited to, FePt, FeNi, and FeCo. In another embodiment, magnetic contact layer 108A/108B is a rare-earth free permanent magnets, for example, Fe₁₆N₂. In another embodiment, magnetic contact layer 108A/108B includes ferromagnetic particles embedded within a conductive matrix. The ferromagnetic particles may be formed, for example, from the ferromagnetic materials listed above. The conductive matrix material may be any appropriate conductive material. In an embodiment, the conductive matrix material is a solder material, for example, but not limited to, SnCu, SnAg, SnCuAg, SnIn, SnBi, and combinations thereof.

In another embodiment, magnetic contact layer 108A/108B is formed from a paramagnetic material. Exposing a paramagnetic material to an external magnetic field may induce magnetic alignment within the paramagnetic material, which randomizes upon removal of the external magnetic field. An external field may be applied to interconnect structure 100 to induce opposite magnetic polarities 115A and 115B, giving rise to attractive force between magnetic contact layers 108A and 108B. Magnetic contact layer 108A/108B may be formed from paramagnetic materials, such as, but not limited to, magnesium, molybdenum, lithium, and tantalum. In addition, antiferromagnetic materials behave in a paramagnetic manner above the Neel temperature. As such, in an embodiment of the invention, antiferromagnetic materials may be used.

Anisotropic conductive tape (ACT) 112 joins contact surfaces 109A and 109B, according to an embodiment of the invention. ACT 112 may be any commercially available ACT. The ACT 112 is selected such that the maximum size of the conductive particles is smaller than the pitch between adjacent magnetic attachment structures 110A/110B. In an embodiment, the compressed portion 113 of ACT 112 electrically couples opposing contact surfaces 109A and 109B, while the uncompressed portion between adjacent magnetic attachment structures 110A/110B does not conduct electricity.

In an embodiment, the opposing magnetic polarities 115A/115B of magnetic contact layers 108A/108B create an attractive force, which compresses the intervening portion 113 of ACT 112. In an embodiment, greater compressive force leads to greater bulk conductivity of the ACT and greater interfacial conductivity at the interface of the ACT 112 and contact surface 109A or 109B. The materials and dimensions of magnetic layer 108A/108B may be selected to tailor the magnetic attractive force and resulting conductivity between opposing contact surfaces 109A and 109B. In an embodiment, the compressive force exerted by the magnetically attracted magnetic attachment structures 110A/110B on ACT 112 is at least 0.1 MPa to achieve electrical conduction between surfaces 109A and 109B.

In FIG. 1B, interconnect structure 100′ includes an anisotropic conductive paste (ACP) 114 joining opposing magnetic attachment structures 110A/110B according to an embodiment of the invention. In an embodiment, ACP 114 covers sidewalls 117A/117B, filling the space between adjacent magnetic attachment structures 110A/110B in addition to the space between opposing contact surfaces 109A/109B. The magnetic attraction force between opposing magnetic contact surfaces 109A and 109B compresses the intervening portion 113 of ACP 114, forcing the embedded conductive particles (not shown) into contact and creating an electrical path between opposing magnetic attachment structures 110A and 110B. In an embodiment, ACP 114 contacts first surface 102A. In an embodiment, ACP 114 contacts second surface 102B.

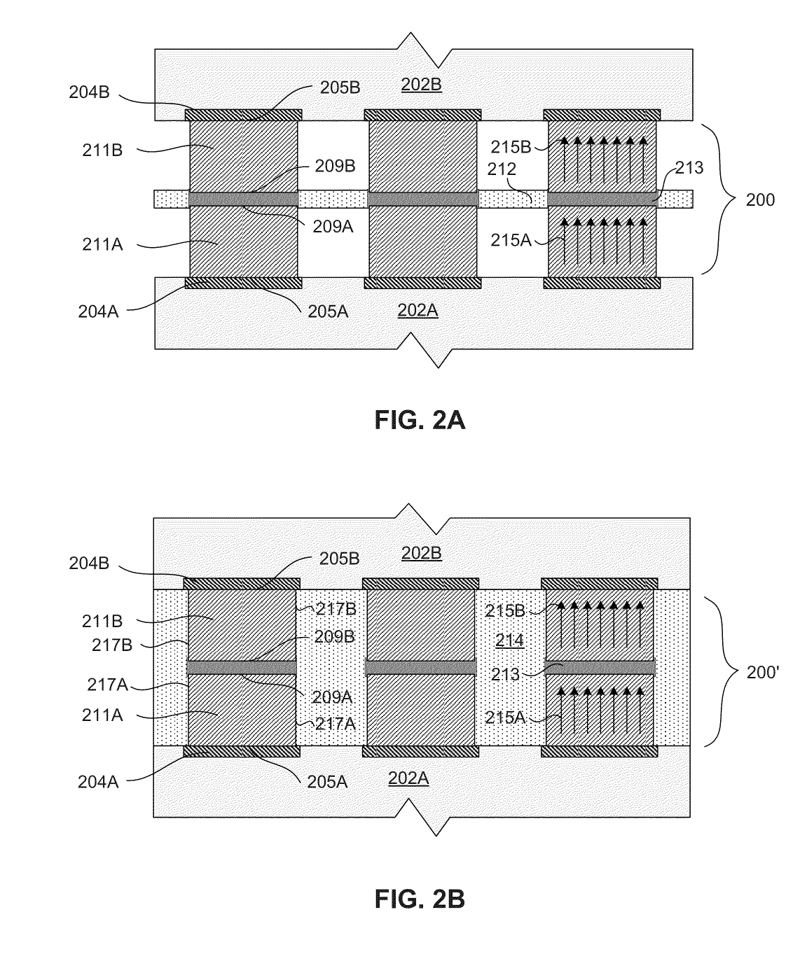

FIGS. 2A-2B illustrate a cross-sectional view of an interconnect structure incorporating an ACA and magnetic attachment structures, according to an embodiment of the invention. In FIG. 2A, first surface 202A is electrically connected to second surface 202B by interconnect structure 200, including magnetic attachment structures 211A/211B and ACT 212, according to an embodiment of the invention. In an embodiment, magnetic attachment structures 211A/211B are formed on conductive pads 204A/204B. First surface 202A and second surface 202B may each correspond to any number of substrates or devices, as discussed above with respect first surface 102A and second surface 102B in FIG. 1A.

Magnetic attachment structures 211A/211B are formed from a magnetic material, according to an embodiment of the invention. In an embodiment, the magnetic attachment structures 211A/211B are formed from a ferromagnetic material, such as those listed above with respect to magnetic layers 108A/108B. In another embodiment, magnetic attachment structures 211A/211B are formed from a paramagnetic material, such as those listed above with respect to magnetic layers 108A/108B. In another embodiment, magnetic attachment structures 211A/211B are formed from an antiferromagnetic material. In an embodiment, magnetic attachment structures 211A/211B each have a land end 205A/205B and a contact surface 209A/209B.

In an embodiment, magnetic attachment structures 211A/211B have a permanent magnetic polarity 215A/215B. The orientation of magnetic polarity 215A normal to contact surface 209A, is opposite that of magnetic polarity 215B normal to the contact surface of 209A, according to an embodiment. The opposite magnetic alignments give rise to an attractive magnetic force between opposing magnetic attachment structures 211A and 211B, which compresses portion 213 of ACT 212 between contact surfaces 209A and 209B. The compression forces conductive particles (not shown) dispersed within portion 213 of ACT 212 into contact to create an electrical path between opposing magnetic attachment structures 211A and 211B. In an embodiment, the compressive force exerted by magnetic attachment structures 211A/211B on ACT 212 is at least 0.1 MPa in order to achieve conduction.

In FIG. 2B, interconnect structure 200′ includes an anisotropic conductive paste (ACP) 214 joining opposing magnetic attachment structures 211A/211B according to an embodiment of the invention. In an embodiment, ACP 214 contacts sidewalls 217A/217B, filling the space between adjacent magnetic attachment structures 211A/211B. In an embodiment, ACP 214 contacts first surface 202A and second surface 202B. The magnetic force between opposing magnetic contact surfaces 209A and 209B compresses portion 213 of ACP 214, forcing the embedded conductive particles (not shown) into contact and creating an electrical path between opposing magnetic attachment structures 211A and 211B.

It is to be understood that the embodiments illustrated and described above with respect to FIGS. 1A-1B and FIGS. 2A-2B are exemplary, and that additional embodiments are within the scope of the invention. For example, a first surface having magnetic attachment structures formed form a magnetic material, as discussed with respect to FIGS. 2A-2B may be joined via ACA with a second surface having magnetic attachment structures including a conductive base and a magnetic layer forming the contact surface, as discussed with respect to FIGS. 1A-1B. In an embodiment, the interconnect structure includes both paramagnetic attachment structures and ferromagnetic attachment structures. In another example, magnetic attachment structures on a first surface are joined via ACA directly to conductive pads from a magnetic material on a second surface. In addition, other types of ACAs may be used, such as anisotropic conductive films (ACFs).

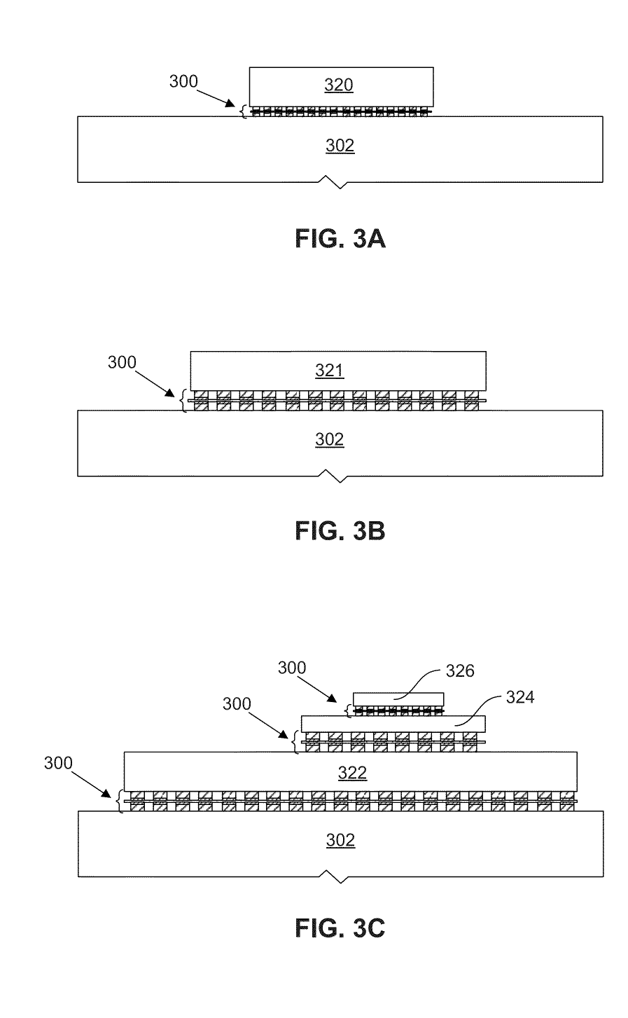

It is to be appreciated that the interconnect structure described above may be used to electrically connect a variety of surfaces in a variety of configurations. For example, FIGS. 3A-3C illustrate a cross-sectional view of semiconductor devices having interconnect structures incorporating an ACA and magnetic attachment structures, according to an embodiment of the invention. In FIG. 3A, a microelectronic die 320 may be a Direct Chip Attach (DCA) die, directly attached to a substrate 302, such as a motherboard. Microelectronic die 320 is electrically and mechanically coupled to substrate 302 via interconnect structure 300. In an embodiment, interconnect structure 300 is sized appropriately for the DCA die 320. In FIG. 3B, a semiconductor package 321 is mounted to substrate 302 via interconnect structure 300, according to an embodiment. In an embodiment, semiconductor package 321 includes a packaged die. Interconnect structure 300 may be appropriately sized for package-scale conductive pads. As shown in FIG. 3C, an interposer 322 may be attached to the substrate 302 via interconnect structure 300. Another microelectronic die 324 may be attached to interposer 322, wherein interposer 322 routes the signals between microelectronic die 322 and substrate 302. Microelectronic die 324 may be attached to interposer 322 through interconnect structure 300. A microelectronic device 326, such as a microelectronic die, may be attached to a back side of the microelectronic die 324. In an embodiment, interconnect structures 300 include magnetic attachment structures and an ACA, as described above with respect to FIGS. 1A-1B and 2A-2B.

It is to be understood that the subject matter of the present description is not limited to the specific examples illustrated in FIGS. 1A-1B, 2A-2B, and 3A-3C. The interconnect structure may be used to electrically connect other types of devices and surfaces. For example, other surface types, such as, but not limited to, organic or ceramic substrates, films, and glass having conductive pads thereon or other types of devices such as electronic modules integrated on PCB or ceramic substrates may be electrically connected using the interconnect structure disclosed herein.

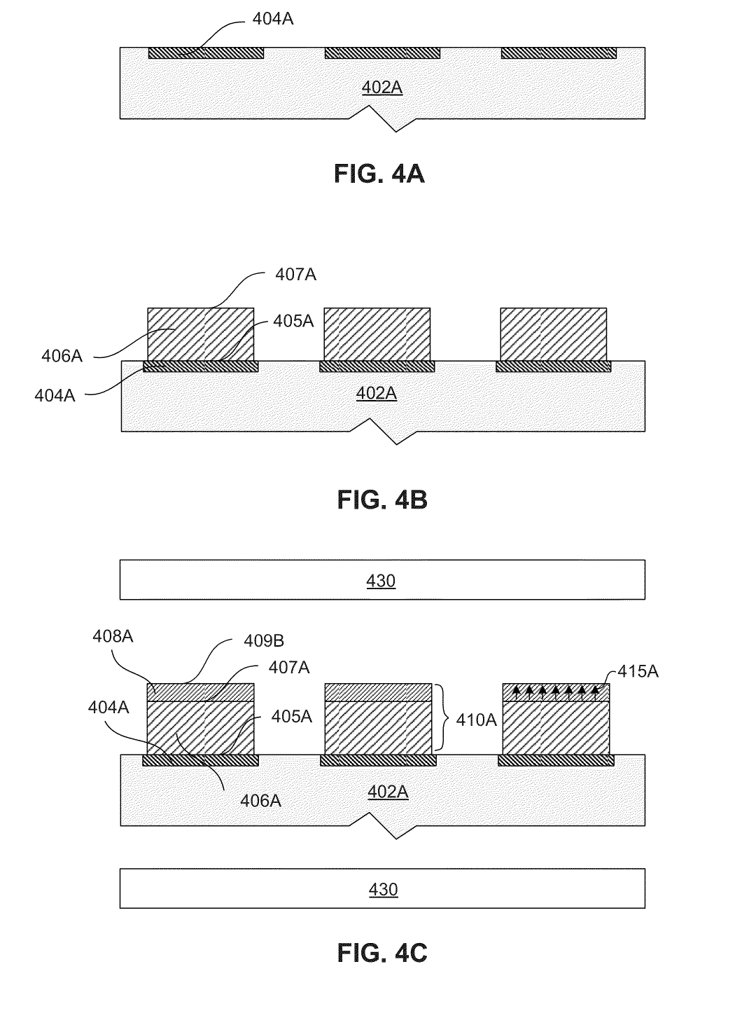

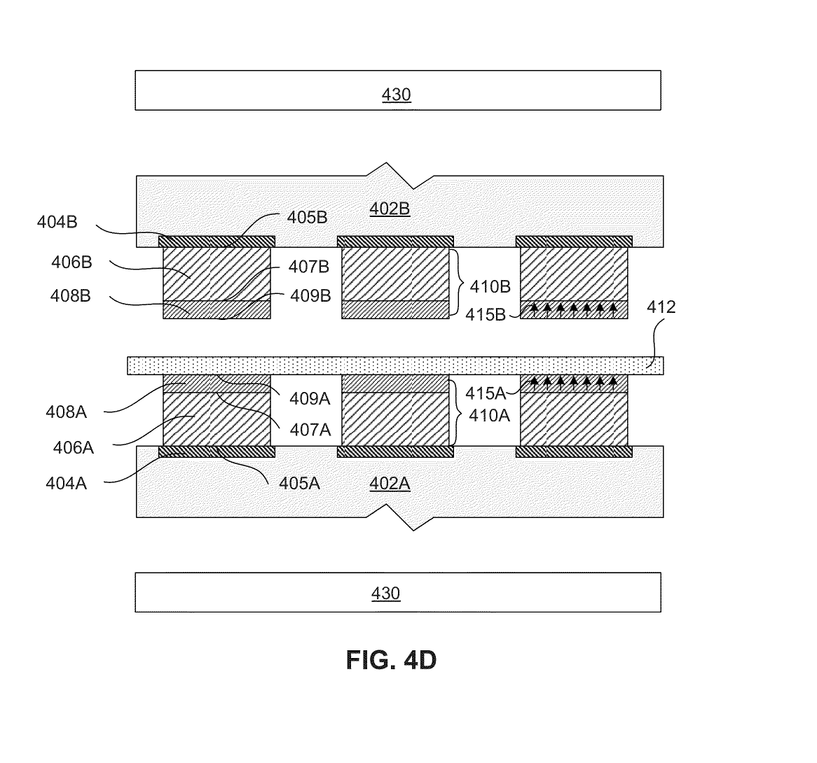

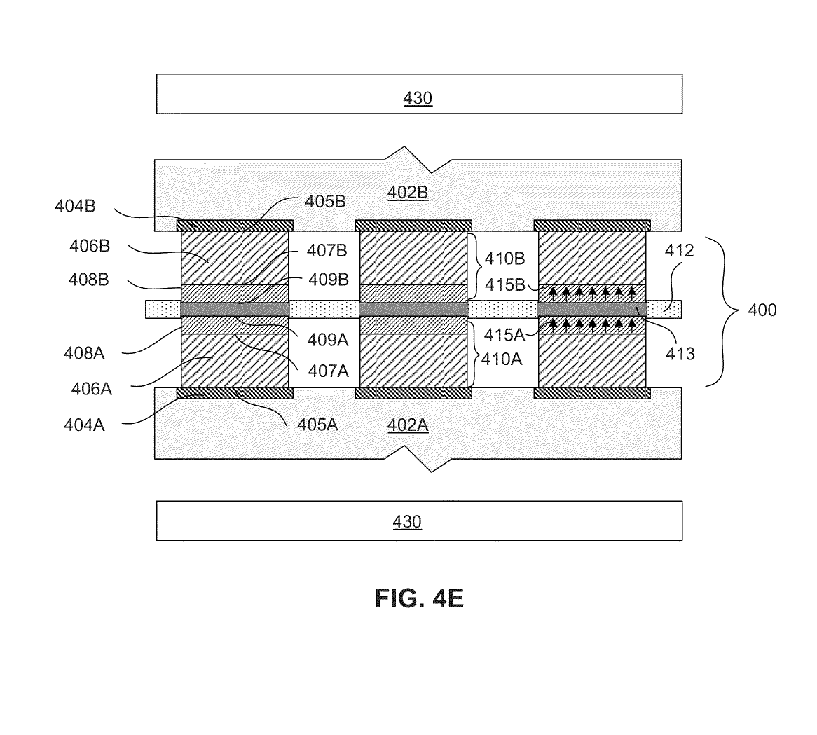

FIGS. 4A-4E illustrate a method for joining two surfaces using magnetic attachment structures and an anisotropic conductive tape (ACT), according to an embodiment of the invention. In FIG. 4A, a first surface 402A is provided, according to an embodiment of the invention. First surface 402A may be the surface of a PCB or other carrier substrate, such as discussed above with respect to first surface 102A in FIG. 1A. In an embodiment, first surface 402A has conductive pads 404A formed therein.

In FIG. 4B, a conductive material 406A is formed on first surface 402A, according to an embodiment of the invention. In an embodiment, conductive material 406A is formed on conductive pads 404A. A mask (not shown) may be used to define conductive material 406A. Conductive material 406A may include, but is not limited to, copper and alloys thereof. In an embodiment, conductive material 406A is deposited with a plating process, including but not limited to electroplating and electroless plating. In another embodiment, conductive material 406A is deposited by various deposition techniques, such as sputtering or vapor deposition. The conductive material has a pad end 405A proximate to the conductive pad 404A and a contact end 407A protruding away from first surface 402A, according to an embodiment.

Next, in FIG. 4C, a magnetic layer 408A is formed over contact end 407A of conductive material 406A to form magnetic attachment structure 410A, according to an embodiment of the invention. In an embodiment, magnetic material 408A is a ferromagnetic material, such as those described above with respect to magnetic layer 108A/108B in FIG. 1A. The material and dimensions of magnetic layer 408A are selected to have a magnetic polarity 415A that generates a magnetic field of sufficient strength to apply adequate pressure an ACA to achieve the desired conductivity. In an embodiment, magnetic layer 408A has a contact surface 409A.

Magnetic layer 408A may be formed by a variety of methods. For example, magnetic layer 408A may be plated by any technique known in the art, including but not limited to electroplating and electroless plating. Additionally, magnetic layer 408A may be deposited by various deposition techniques, such as sputtering, molecular, or vapor deposition, for example, pulsed laser deposition (PLD). In an embodiment, magnetic material is formed on contact end 407A by paste deposition and then reflowed to form magnetic layer 408A. In another embodiment, a solder having magnetic particles dispersed therein is formed on contact end 407A and then reflowed using induction heating to form magnetic layer 408A.

Magnet device 430 is used to define the polarity 415A of magnetic layer 408A, according to an embodiment of the invention. Magnet device 430 may be any appropriate magnet system that generates a magnetic field, including but not limited to a permanent magnet or an electromagnet. In an embodiment, magnetic layer 408A is a ferromagnetic material, and exposure of the material to the magnetic field from magnet device 430 aligns the magnetic dipoles of the domains within the material. The ferromagnetic material retains at least some degree of alignment after removal of the magnetic field, exhibiting magnetic polarity 415A. In an embodiment, the magnetic field from magnet device 430 is applied during the formation of magnetic layer 408A on contact end 407A. In another embodiment, the magnetic field from magnet device 430 is applied after the formation of magnetic layer 408A on contact end 407A. In either case, where magnetic layers 408A include a ferromagnetic material, the resulting magnetic polarity 415A is aligned with the magnetic field generated by magnet device 430. In an embodiment, magnetic layer 408A is heated while the magnetic field from magnet device 430 is applied in order to lower the magnitude of the magnetic field required to achieve the desired degree of polarity 415A in magnetic layer 408A. By defining or inducing magnetic polarity 415A in magnetic layers 408A using magnet device 430, magnetic layers 408A are attracted to magnetic layers or contacts having an opposite polarity.

Next, in FIG. 4D, ACT 412 is applied over magnetic attachment structures 410A on first surface 402A in order to be joined to magnetic structures 410B on a second surface 402B, according to an embodiment of the invention. Second surface 402B may be the surface of a semiconductor package or device, such as described above with respect to second surface 102B in FIG. 1A. Second surface 402B is provided having at least one magnetic attachment structure 410B formed thereon, according to an embodiment. Second surface 402B may include conductive pads 404B formed therein. In an embodiment, magnetic attachment structures 410B include a conductive material 406B having a pad end 405B contacting conductive pad 404B and a contact end 407B having magnetic layer 408B formed thereon. Magnetic attachment structures 410B may be formed on second surface 402B as described above with respect to magnetic attachment structures 410A on first surface 402A.

In an embodiment, ACT 412 is applied to the contact surfaces 409A of magnetic attachment structures 410A. ACT 412 may be applied over a plurality of magnetic contact structures 410A. In another embodiment, ACT 412 is applied to magnetic attachment structures 410B on second surface 402B. In the uncompressed state, ACT 412 is non-conductive, due to the insulating properties of the matrix material.

In an embodiment, magnetic attachment structures 410B have a magnetic polarity 415B normal to the contact surface 409B that is opposite that of magnetic polarity 415A normal to contact surface 409A. The opposite magnetic polarities 415A and 415B may assist in the alignment of first surface 402A and second surface 402B. Magnetic polarities 415A/415B may be permanent, as for a ferromagnetic layer 408A/408B, or temporary, as for a paramagnetic layer 408A/408B. For a paramagnetic layer 408A/408B, magnetic polarity 415A/415B is induced by an external magnetic field applied by magnet device 430. In an embodiment where one magnetic layer 408A/408B is ferromagnetic and the opposing magnetic layer 408A/408B is paramagnetic, the externally applied magnetic field from magnet device 430 is aligned to induce a paramagnetic polarity 415A/415B that is opposite the ferromagnetic polarity 415A/415B. For example, in an embodiment, magnetic layer 408A is ferromagnetic and has a permanent magnetic polarity 415A, while magnetic layer 408B is paramagnetic and has magnetic polarity 415B induced by magnet device 430 to be opposite that of magnetic polarity 415A.

In FIG. 4E, the magnetic attachment structures 410A on first surface 402A, having ACT 412 thereon, are then brought into contact with the magnetic attachment structures 410B on second surface 402B, so that opposing magnetic attachment structures 410A and 410B are in alignment, according to an embodiment. Interconnect structure 400 includes magnetic attachment structures 410B on second surface 402B and magnetic attachment structures 410A on first surface 402A joined via ACT 412, according to an embodiment of the invention. The magnetic attraction between opposing magnetic layers 408A and 408B compresses the intervening portion 413 of ACT 412 between contact surfaces 409A and 409B, according to an embodiment. In an embodiment, the compressive force on intervening portion 413 of ACT 412 due to magnetic attraction between magnetic layers 408A and 408B improves the conductivity between magnetic attachment structures 410A and 410B. In an embodiment, ACT 412 is cured after joining magnetic attachment structures 410A and 410B.

In an embodiment where one or both magnetic contact layers 408A/408B are paramagnetic, the magnetic field from magnet device 430 is applied while joining first surface 402A and second surface 402B to induce polarities 415A/415B, creating an attractive force between opposing magnetic attachment structures 410A and 410B. In an embodiment where one contact layer 408A/408B is ferromagnetic and the opposing contact layer 408A/408B is paramagnetic, the externally applied magnetic field is aligned to induce a magnetic polarity 415A/415B in the paramagnetic layer that is opposite that of the ferromagnetic layer. In an embodiment, ACT 412 is cured while the external magnetic field is applied, so that when the magnetic field is removed, the conductive particles within ACT 412 and the magnetic attachment structures 410A/410B are held in place to sustain conductivity.

The interconnection method described above with reference to FIGS. 4A-4E may be carried out at room temperature or at relatively low temperatures as compared the temperatures required for conventional solder-based interconnection methods, for example less than 200° C. In addition, the use of ACT as opposed to solder joints may enable reworkability of the interconnect structure.

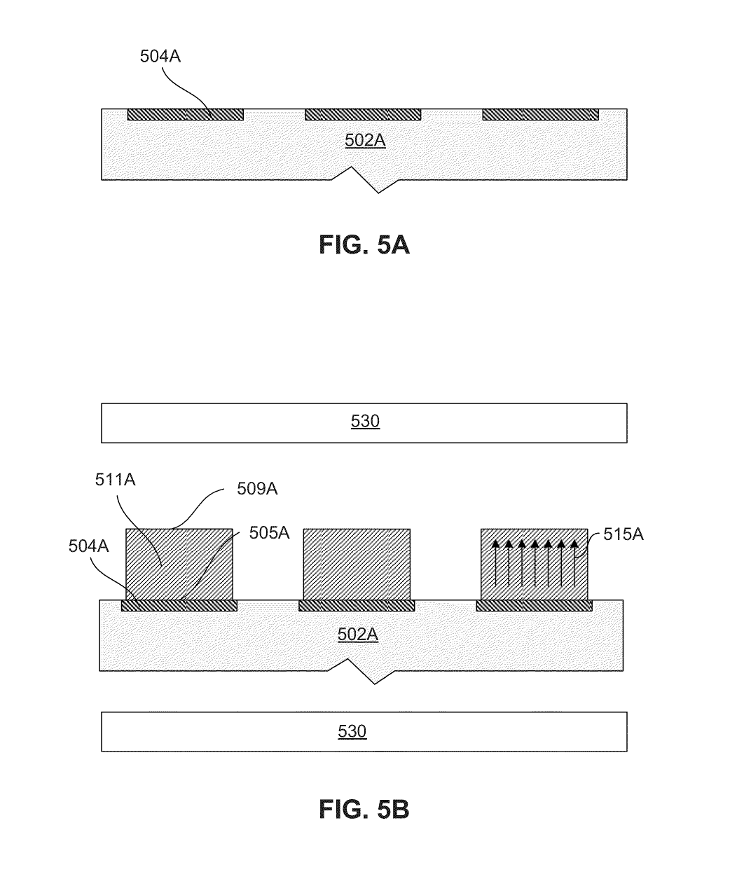

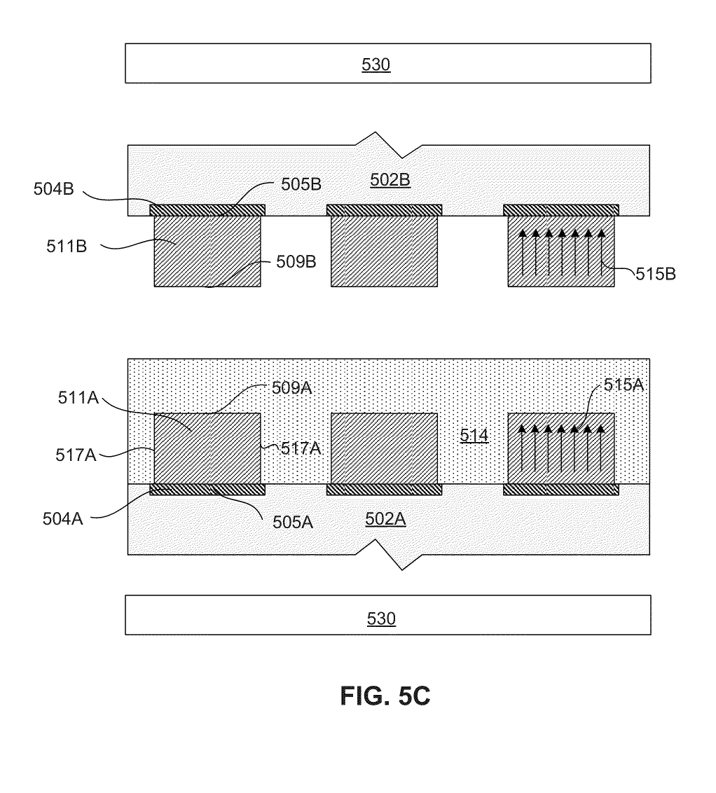

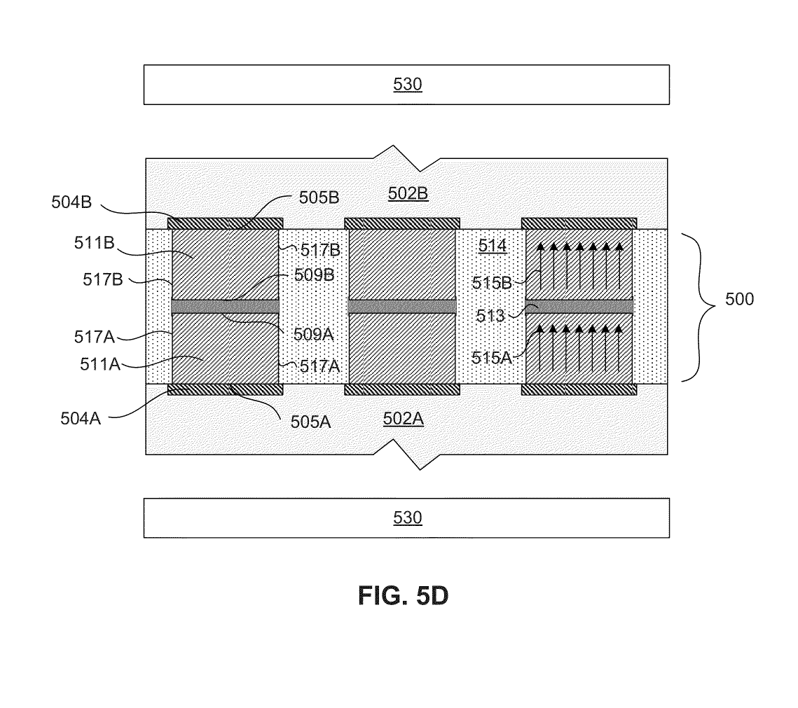

FIGS. 5A-5D illustrate a method for joining two surfaces using magnetic attachment structures and an anisotropic conductive paste (ACP), according to an embodiment of the invention. For example, as compared to the magnetic attachment structures shown in FIGS. 1A-1B and formed in FIGS. 4A-4E, where the magnetic material is formed over a conductive material, FIGS. 5A-5D illustrate an embodiment where the magnetic material is formed over a conductive pad within a surface. In FIG. 5A, a first surface 502A is provided, according to an embodiment of the invention. First surface 502A may be the surface of a PCB or other carrier substrate, such as discussed above with respect to first surface 102A in FIG. 1A. In an embodiment, first surface 502A has conductive pads 504A formed therein.

Next, in FIG. 5B, magnetic attachment structures 511A are formed on first surface 502A, according to an embodiment of the invention. Magnetic attachment structures 511A each have a contact surface 509A and land surface 505A, according to an embodiment. Magnetic attachment structures may include a ferromagnetic, paramagnetic, or antiferromagnetic material, as discussed above with respect to magnetic attachment structures 211 in FIGS. 2A-2B. In an embodiment, magnetic attachment structures 511A are each formed over a conductive pad 504A.

Magnetic attachment structures 511A may be formed by deposition or plating, as discussed above with respect to magnetic layers 408A. In an embodiment, magnetic material is formed over conductive pad 504A by paste deposition and then reflowed to form magnetic attachment structure 511A. In another embodiment, a solder having magnetic particles dispersed therein is formed over conductive pad 504A and then reflowed using induction heating to form magnetic attachment structure 511A.

In an embodiment, magnet device 530 is used to align the magnetic polarity 515A of ferromagnetic magnetic attachment structures 511A. A magnetic field from magnet device 530 may be applied to magnetic attachment structures 511A during formation or after formation. In an embodiment, a magnetic field from magnet device 530 is applied while magnetic attachment structures 511A are heated. Heating magnetic attachment structures 511A lowers the magnitude of the magnetic field required to reach saturation, which may facilitate alignment of the magnetic dipoles within magnetic attachment structures 511A.

Next, in FIG. 5C, ACP 514 is applied to first surface 502A in order to join first surface 502A to a second surface 502B, according to an embodiment of the invention. Second surface 502B is provided having at least one magnetic attachment structure 511B formed thereon, according to an embodiment. Second surface 502B may include conductive pads 504B formed therein. Magnetic attachment structures 511B may be formed on second surface 502B as described above with respect to magnetic attachment structures 511A on first surface 502A. In an embodiment, the orientation of magnetic polarity 515B normal to contact surface 509B is opposite the orientation of magnetic polarity 515A normal to opposing contact surface 509A, so that magnetic attachment structures 511B are magnetically attracted to magnetic attachment structures 511A. In another embodiment, magnetic attachment structures 511B are paramagnetic, and a temporary magnetic polarity 515B induced by an electric field externally applied from magnet device 530 assists in the alignment of magnetic attachment structures 511A and 511B.

In an embodiment, ACP 514 is dispensed over magnetic attachment structures 511A. In an embodiment, ACP 514 covers contact surfaces 509A and sidewalls 517A of magnetic attachment structures 511A, filling the spaces between adjacent attachment structures. In an embodiment, ACP 514 contacts first surface 502A. In another embodiment, ACP 514 is applied first over magnetic attachment structures 511B on second surface 502B. In another embodiment, ACP 514 is applied over both magnetic attachment structures 511A on first surface 502A and magnetic attachment structures 511B on second surface 502B. The magnetic attraction between polarities 515A of magnetic attachment structures 511A and opposing magnetic polarity 515B of magnetic attachment structures 511B may be used to assist in the alignment of the contact surfaces 509A/509B. In an embodiment, a magnetic field from magnet device 530 is used to induce magnetic polarity 515A/515B in paramagnetic attachment structures 511A and 511B in order to assist in the alignment of contact surfaces 509A/509B.

In FIG. 5D, magnetic attachment structures 511A on first surface 502A, having ACP 514 thereon, are joined with magnetic attachment structures 511B on second surface 502B, according to an embodiment of the invention. Interconnect structure 500 includes magnetic attachment structures 511B on second surface 502B and magnetic attachment structures 511A on first surface 502A joined via ACP 514, according to an embodiment of the invention. When joined, ACP 514 may fill the space between adjacent magnetic contact structures 511A and 511B, covering contact surfaces 509A/509B, sidewalls 517A/517B, and exposed portions of first surface 502A and second surface 502B. Magnetic polarities 515A/515B may be permanent, as for a ferromagnetic attachment structure 511A/511B, or induced by magnet device 530, as for a paramagnetic or antiferromagnetic attachment structure 511A/511B. The magnetic polarities 515A/515B compress portions 513 of ACP 514 to establish an electrical connection between contact surfaces 509A/509B. In an embodiment, ACP 514 is cured after joining magnetic attachment structures 511A and 511B.

It is to be understood that the magnetic attachment structures 410A/410B formed in FIGS. 4A-4C may be joined using other types of ACA's, such as an ACP, as shown in FIG. 5D, or an ACF. Similarly, magnetic attachment structures 511A/511B formed in FIGS. 5A-5B may be joined using other types of ACA's, such as an ACT, as shown in FIG. 4E, or an ACF. Additionally, a surface having magnetic attachment structures of the type shown in FIG. 4C, including a magnetic layer, may be joined with a surface having magnetic attachment structures of the type shown in FIG. 5B.

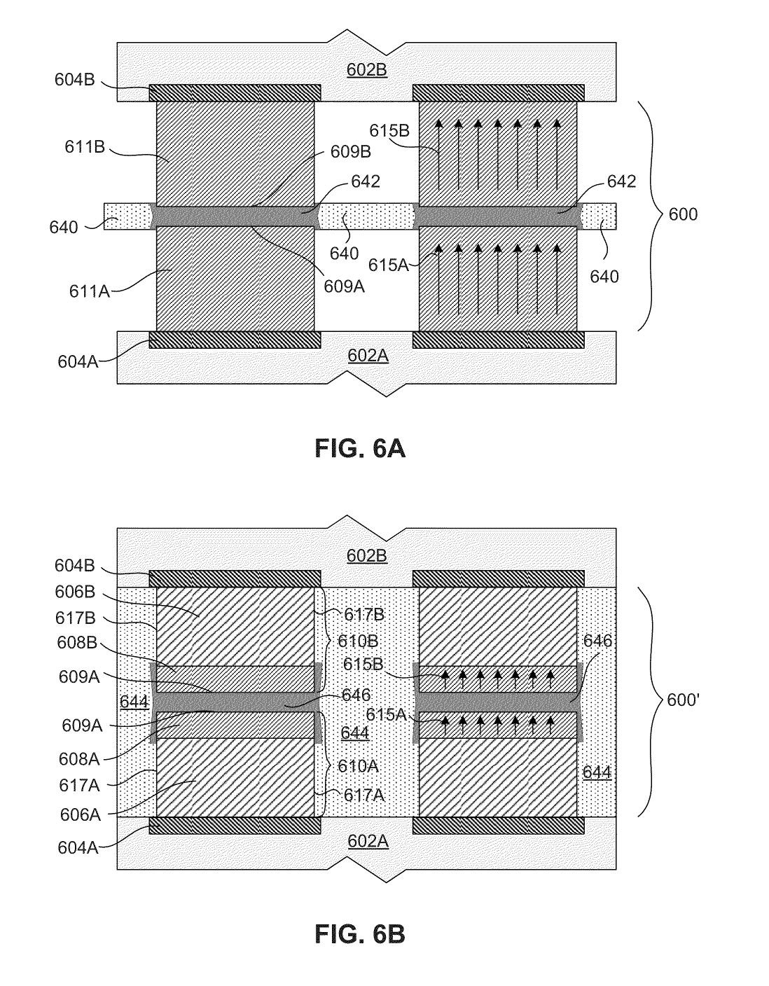

FIGS. 6A-6B illustrate cross-sectional views of interconnect structures incorporating a magnetic anisotropic conductive adhesive and magnetic attachment structures, according to an embodiment of the invention. In FIG. 6A, interconnect structure 600 electrically joining first surface 602A and second surface 602B includes magnetic attachment structures 611A/611B and magnetic ACA 640, according to an embodiment. First surface 602A and second surface 602B may be the surface of a microelectronic substrate or semiconductor device, such as discussed above with respect to first surface 102A and second surface 102B in FIG. 1A. In an embodiment, magnetic attachment structures 611A/611B are formed over conductive pads 604A/604B. Magnetic attachment structures 611A/611B include a magnetic material, so that an attractive force exists between contact surfaces 609A and 609B, either due to the presence of permanent polarities 615A and 615B, as for a ferromagnetic material, or due to induced polarities 615A and 615B, as for a paramagnetic material. ACA 640 may also be used with magnetic attachment structures including a magnetic layer formed over a conductive material.

Magnetic ACA 640 joins the contact surfaces 609A and 609B of opposing magnetic attachment structures 611A and 611B, according to an embodiment of the invention. In an embodiment, magnetic ACA 640 is a tape. In another embodiment, magnetic ACA 640 is a film. In an embodiment, magnetic ACA 640 includes magnetic conductive particles (not shown) dispersed within an insulating matrix material. The magnetic field between opposing magnetic attachment structures 611A and 611B exerts an attractive force on the magnetic conductive particles dispersed within the magnetic ACA 640. In an embodiment, the attractive force increases the concentration of particles in the contact region 642 between magnetic contact surfaces 609A and 609B, while depleting or reducing the concentration of particles in the uncompressed portion of the magnetic ACA 640 between adjacent magnetic attachment structures. The higher concentration of magnetic conductive particles in the contact region 642 of the magnetic contact surfaces 609A and 609B increases the anisotropic property of the adhesive, leading to improved electrical conductivity of the interconnection while also improving isolation between adjacent attachment structures.

The magnetic conductive particles may have a variety of shapes, including, but not limited to spheres, rods, and wires. The particle size may be tailored to the specific interconnect application for which the magnetic ACA will be used. In an embodiment, the magnetic conductive particles have a diameter less than 25 μm. In an embodiment, the magnetic conductive particles include a ferromagnetic material, for example, but not limited to, Sm₁Co₅, Sm₂Co₁₇, Sm₃Co₂₉, Nd₂Fe₁₄B alloys, FePt, FeNi, FeCo, and rare-earth magnets. In another embodiment, the magnetic conductive particles include a paramagnetic material, for example, but not limited to, zinc, platinum, tungsten, gold, aluminum, and copper. Magnetic ACA 640 may additionally comprise non-magnetic conductive particles and non-conductive particles. Non-conductive particles may be incorporated to control the risk of shorting between adjacent contact structures, or to tailor the thermal properties of magnetic ACA 640, for example, the coefficient of thermal expansion (CTE).

In an embodiment, the matrix material of the ACA 640 is selected to enable limited mobility of the magnetic conductive particles to enable concentration in the contact region 642. The matrix material may include, for example, but not limited to, epoxy resins, PTFE, rubbers, and acrylics. In an embodiment, the matrix material is curable. The ACA 640 may be uncured when applied to magnetic attachment structures 611A/611B, and then cured after joining the structures and respective substrates 602A/602B.

FIG. 6B illustrates an embodiment of the magnetic ACA where the matrix material is a paste. In an embodiment, the magnetic particles (not shown) included in magnetic ACA 644 are dispersed throughout the paste matrix. The paste matrix material may be selected to enable limited mobility of the conductive particles. For example, the paste matrix material may be, but is not limited to, epoxy, rubbers, and acrylics.

In an embodiment, interconnect structure 600′ joining first surface 602A and second surface 602B includes magnetic attachment structures 610A/610B joined by magnetic anisotropic conductive paste (ACP) 644, according to an embodiment of the invention. Magnetic attachment structures 610A/610B may be formed on conductive pads 604A/604B within surfaces 602A/602B. In an embodiment, magnetic attachment structures 610A/610B each include conductive material 606A/606B and magnetic layer 608A/608B. Magnetic layers 608A/608B have opposing magnetic polarities 615A/615B, according to an embodiment. Magnetic polarities 615A/615B may be permanent or induced by an external magnet device.

The magnetic field between opposing magnetic layers 608A and 608B exerts an attractive force on the magnetic conductive particles dispersed within the magnetic ACA 644. In an embodiment, the attractive force increases the concentration of particles in the contact region 646 between magnetic contact surfaces 609A and 609B, while depleting the concentration of particles in the uncompressed portion of the magnetic ACA 644 between adjacent magnetic attachment structures. Magnetic particles may be especially mobile through the paste matrix prior to curing. The higher concentration of magnetic conductive particles in the contact region 646 of the magnetic contact surfaces 609A and 609B leads to improved electrical conductivity between contact surfaces 609A/609B and improved electrical isolation between adjacent interconnects.

The use of magnetic attachment structures 610A/610B having magnetic layers 608A/608B confines contact region 646 having a higher concentration of magnetic conductive particles to the vicinity of contact surfaces 609A/609B, according to an embodiment. However, magnetic ACA 644 may also be used with magnetic attachment structures such as those shown in FIG. 6A, in which case the concentration of magnetic conductive particles would also increase around the side surfaces 617A/617B of magnetic contact structures 610A/610B.

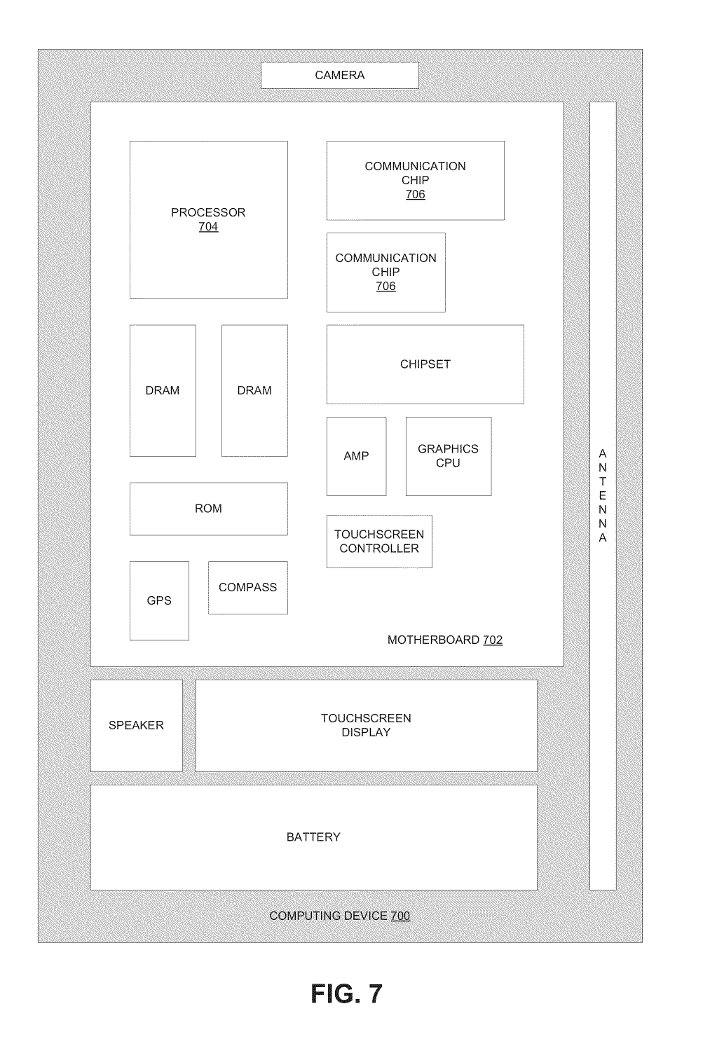

FIG. 7 illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704.

Depending on its applications, computing device 700 may include other components that may or may not be physically and electrically coupled to the board 702. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). In an embodiment, these other components are coupled to the board 702 using interconnect structures including an ACA and magnetic attachment structures, as described above.

The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3 G, 4 G, 5 G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others. The communication chip 706 also includes an integrated circuit die packaged within the communication chip 706. In an embodiment, the communication chip 706 is electrically coupled to the board 702 using interconnect structures including an ACA and magnetic attachment structures, as described above.

The processor 704 of the computing device 700 includes an integrated circuit die packaged within the processor 704. In an embodiment, processor 704 is coupled to the board 702 using interconnect structures including an ACA and magnetic attachment structures, as described above. The term “processor” may refer to any device or portion of a device that processes electronic data from registers and/or memory to transform that electronic data into other electronic data that may be stored in registers and/or memory.

In various implementations, the computing device 700 may be a laptop, a netbook, a notebook, an ultrabook, a smartphone, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. In further implementations, the computing device 700 may be any other electronic device that processes data.

An embodiment of the structure comprises a first magnetic attachment structure disposed on a first surface, a second magnetic attachment structure disposed on a second surface, wherein the second magnetic attachment structure is magnetically attracted to the first magnetic attachment structure, and an anisotropic conductive adhesive electrically coupling the first magnetic attachment structure and second magnetic attachment structure. The first magnetic attachment structure and the second magnetic attachment structure may each comprise a ferromagnetic material. The ferromagnetic material may be selected from the group consisting of Sm₁Co₅, Sm₂Co₁₇, Sm₃Co₂₉, Nd₂Fe₁₄B alloys, FePt, FeNi, FeCo based alloys, and rare-earth magnets. The ferromagnetic material may be a composite comprising ferromagnetic particles embedded in a matrix material. In an embodiment, the matrix material comprises a solder material. In an embodiment, the ferromagnetic particles are selected from the group consisting of Sm₁Co₅, Sm₂Co₁₇, Sm₃Co₂₉, Nd₂Fe₁₄B alloys, FePt, FeNi, FeCo, and rare-earth magnets. At least one of the first magnetic attachment structure and second magnetic attachment structure may comprise a layer of ferromagnetic material formed over a conductive material. In an embodiment, the layer of ferromagnetic material is from 5 nm to 25 μm thick. The anisotropic conductive adhesive may be an anisotropic conductive tape or an anisotropic conductive paste. In an embodiment, the first substrate is a printed circuit board. In an embodiment, the second substrate is a package substrate.

In an embodiment, a method for electrically coupling a first surface with a second surface comprises forming a first magnetic attachment structure on the first surface, forming a second magnetic attachment structure on the second surface, wherein the second magnetic attachment structure is magnetically attracted to the first magnetic attachment structure, and disposing an anisotropic conductive adhesive between the first magnetic attachment structure and the second magnetic attachment structure. In an embodiment, disposing an anisotropic conductive adhesive between the first magnetic attachment structure and the second magnetic attachment structure comprises applying an anisotropic conductive paste over a first contact surface of the first magnetic attachment structure and contacting a second contact surface of the second magnetic attachment structure with the anisotropic conductive paste in alignment with the first magnetic attachment structure. In an embodiment, disposing an anisotropic conductive adhesive between the first magnetic attachment structure and the second magnetic attachment structure comprises applying an anisotropic conductive tape over a first contact surface of the first magnetic attachment structure, and contacting a second contact surface of the second magnetic attachment structure with the anisotropic conductive tape in alignment with the first magnetic attachment structure. In an embodiment, the anisotropic conductive adhesive may be cured. In an embodiment, forming at least one of the first magnetic attachment structure and second magnetic attachment structure comprises deposition of a magnetic material. In an embodiment, forming at least one of the first magnetic attachment structure and second magnetic attachment structure comprises plating a magnetic material. At least one of forming the first magnetic attachment structure and forming the second magnetic attachment structure may further comprise heating at least one of the first magnetic attachment structure and second magnetic contact structure using induction. In an embodiment, forming at least one of the first magnetic attachment structure and second magnetic attachment structure comprises forming a conductive material on one of the first surface and the second surface, wherein the conductive material has a contact surface and forming a layer of magnetic material over the contact surface. In an embodiment, the method further comprises exposing at least one of the first magnetic attachment structure and second magnetic attachment structure to a magnetic field. In an embodiment, the method further comprises annealing the magnetic attachment structure in the presence of a magnetic field. In an embodiment, the method further comprises applying pressure to compress the anisotropic conductive adhesive between the first magnetic attachment structure and second magnetic attachment structure.

In an embodiment, a method comprises forming a first magnetic attachment structure on a first surface, forming a second magnetic attachment structure on a second surface, wherein at least one of the first magnetic attachment structure and the second magnetic attachment structure includes a paramagnetic material, disposing an anisotropic conductive adhesive between the first magnetic attachment structure and the second magnetic attachment structure, applying a magnetic field to induce a magnetic attraction between the first magnetic attachment structure and second magnetic attachment structure, and curing the anisotropic conductive adhesive. In an embodiment, the magnetic field is applied prior to disposing the anisotropic conductive adhesive between the first magnetic attachment structure and the second magnetic attachment structure. In an embodiment, the magnetic field is removed prior to curing the anisotropic conductive adhesive. In an embodiment, the magnetic field is removed after curing the anisotropic conductive adhesive.

In an embodiment, an anisotropic conductive adhesive comprises an insulative adhesive matrix, and ferromagnetic conductive particles dispersed throughout the insulative adhesive matrix. In an embodiment, the ferromagnetic conductive particles comprise a material selected from the group consisting of Sm₁Co₅, Sm₂Co₁₇, Sm₃Co₂₉, Nd₂Fe₁₄B alloys, FePt, FeNi, FeCo, and rare-earth magnets. In an embodiment, the ferromagnetic conductive particles have an average diameter less than 25 μm.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the internal spacers and the related structures and methods discussed herein may be implemented in a variety of embodiments, and that the foregoing discussion of certain of these embodiments does not necessarily represent a complete description of all possible embodiments.

Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A structure, comprising:
a first magnetic attachment structure disposed on a first surface;
a second magnetic attachment structure disposed on a second surface, wherein the second magnetic attachment structure is magnetically attracted to the first magnetic attachment structure; and
an anisotropic conductive adhesive electrically coupling the first magnetic attachment structure and second magnetic attachment structure.

2. The structure of claim 1, wherein the first magnetic attachment structure and the second magnetic attachment structure each comprise a ferromagnetic material.

3. The structure of claim 2, wherein the ferromagnetic material is selected from the group consisting of Sm₁CO₅, Sm₂Co₁₇, Sm₃Co₂₉, Nd₂Fe₁₄B alloys, FePt, FeNi, FeCo based alloys, and rare-earth magnets.

4. The structure of claim 2, wherein the ferromagnetic material is a composite comprising ferromagnetic particles embedded in a matrix material.

5. The structure of claim 4, wherein the matrix material comprises a solder material.

6. The structure of claim 4, wherein the ferromagnetic particles are selected from the group consisting of Sm₁Co₅, Sm₂Co₁₇, Sm₃Co₂₉, Nd₂Fe₁₄B alloys, FePt, FeNi, FeCo, and rare-earth magnets.

7. The structure of claim 2, wherein at least one of the first magnetic attachment structure and second magnetic attachment structure comprises a layer of ferromagnetic material formed over a conductive material.

8. The structure of claim 7, wherein the layer of ferromagnetic material is from 5 nm to 25 μm thick.

9. The structure of claim 1, wherein the anisotropic conductive adhesive is an anisotropic conductive tape.

10. The structure of claim 1, wherein the anisotropic conductive adhesive is an anisotropic conductive paste.

11. The structure of claim 1, wherein the first substrate is a printed circuit board.

12. The structure of claim 1, wherein the second substrate is a package substrate.

13. A method for electrically coupling a first surface with a second surface, comprising:
forming a first magnetic attachment structure on the first surface;
forming a second magnetic attachment structure on the second surface, wherein the second magnetic attachment structure is magnetically attracted to the first magnetic attachment structure; and
disposing an anisotropic conductive adhesive between the first magnetic attachment structure and the second magnetic attachment structure.

14. The method of claim 13, wherein disposing an anisotropic conductive adhesive between the first magnetic attachment structure and the second magnetic attachment structure comprises:
applying an anisotropic conductive paste over a first contact surface of the first magnetic attachment structure; and
contacting a second contact surface of the second magnetic attachment structure with the anisotropic conductive paste in alignment with the first magnetic attachment structure.

15. The method of claim 13, wherein disposing an anisotropic conductive adhesive between the first magnetic attachment structure and the second magnetic attachment structure comprises:
applying a first side of an anisotropic conductive tape over a first contact surface of the first magnetic attachment structure; and
contacting a second contact surface of the second magnetic attachment structure with a second side of the anisotropic conductive tape in alignment with the first magnetic attachment structure.

16. The method of claim 13, further comprising curing the anisotropic conductive adhesive.

17. The method of claim 13, wherein forming at least one of the first magnetic attachment structure and second magnetic attachment structure comprises deposition of a magnetic material.

18. The method of claim 13, wherein forming at least one of the first magnetic attachment structure and second magnetic attachment structure comprises plating a magnetic material.

19. The method of claim 13, wherein at least one of forming the first magnetic attachment structure and forming the second magnetic attachment structure further comprises heating at least one of the first magnetic attachment structure and second magnetic contact structure using induction.

20. The method of claim 13, wherein forming at least one of the first magnetic attachment structure and second magnetic attachment structure comprises:
forming a conductive material on one of the first surface and the second surface, wherein the conductive material has a contact surface; and
forming a layer of magnetic material over the contact surface.

21. The method of claim 13, further comprising exposing at least one of the first magnetic attachment structure and second magnetic attachment structure to a magnetic field.

22. The method of claim 13, further comprising annealing the magnetic attachment structure in the presence of a magnetic field.

23. The method of claim 13, further comprising applying pressure to compress the anisotropic conductive adhesive between the first magnetic attachment structure and second magnetic attachment structure.

24. A method, comprising:
forming a first magnetic attachment structure on a first surface;
forming a second magnetic attachment structure on a second surface, wherein at least one of the first magnetic attachment structure and the second magnetic attachment structure includes a paramagnetic material;
disposing an anisotropic conductive adhesive between the first magnetic attachment structure and the second magnetic attachment structure;
applying a magnetic field to induce a magnetic attraction between the first magnetic attachment structure and second magnetic attachment structure; and
curing the anisotropic conductive adhesive.

25. The method of claim 24, wherein the magnetic field is applied prior to disposing the anisotropic conductive adhesive between the first magnetic attachment structure and the second magnetic attachment structure.

26. The method of claim 24, wherein the magnetic field is removed prior to curing the anisotropic conductive adhesive.

27. The method of claim 24, wherein the magnetic field is removed after curing the anisotropic conductive adhesive.

28. An anisotropic conductive adhesive comprising:
an insulative adhesive matrix; and
ferromagnetic conductive particles dispersed throughout the insulative adhesive matrix.

29. The anisotropic conductive adhesive of claim 28, wherein the ferromagnetic conductive particles comprise a material selected from the group consisting of Sm₁Co₅, Sm₂Co₁₇, Sm₃Co₂₉, Nd₂Fe₁₄B alloys, FePt, FeNi, FeCo, and rare-earth magnets.

30. The anisotropic conductive adhesive of claim 28, wherein the ferromagnetic conductive particles have an average diameter less than 25 μm.
